(19) United States
(12) Patent Application Publication
(10) Pub. No.: US 2007/0216641 A1
(43) Pub. Date: Sep. 20, 2007

(54) User interface stabilization method and system

(75) Inventors: Hoi L. Young, Lake Villa, IL (US); Michael Bohan, Fox Lake, IL (US); Conor P. O'Sullivan, Chicago, IL (US); Chad A. Phipps, Grayslake, IL (US); Elisa S. Vargas, Chicago, IL (US)

Correspondence Address: LAW OFFICES OF CHARLES W. BETHARDS, LLP, P.O. BOX 1622, COLLEYVILLE, TX, 76034, US

(73) Assignee: Motorola, Inc.

(21) Appl. No.: 11/384,732

(22) Filed: Mar. 20, 2006

(51) Int. Cl. G09G 5/00

(52) U.S. Cl. 345/156

(57) ABSTRACT

Methods (800, 1000) and a corresponding system (100, 200) are configured for mitigating effects of motion induced variability caused by a user or the environment while the user interacts with a device. One method includes determining whether stabilization of input data is required and if so applying stabilization and outputting or displaying the stabilized data. Another method includes monitoring input data and moving a display element as well as a target element based on the input data.

### FIELD OF THE INVENTION

This invention relates in general to User Interface(s) (UI) for devices and more specifically to a system and method for mitigating effects of motion induced variability caused by a user or the environment while the user interacts with a device.

### BACKGROUND OF THE INVENTION

In many modern devices, such as handheld computers, games, phones and Personal Digital Assistants (PDAs), the User Interface (UI) interaction is susceptible to motion induced variability. The motion induced variability can be caused by many factors including user behavior and also environmental causes. When motion induced variability is too prominent then it can cause error-prone interactions that frustrate the user.

Motion induced variability is common with handheld devices partially because people ambulate while using these devices, and also due to use of these handheld devices while riding on a train, in a car or otherwise while in motion. Moreover with the ageing population, maladies such as Essential tremor, Parkinson's disease, and other such conditions may make handheld devices hard to use—often frustrating the user.

Prior art techniques have been devised to address the motion induced variability by, for example, applying a sensor to detect the motion induced by the user or the environment and then use this sensed motion to adapt the operation of the UI. A sensor adds unnecessary complexity as well as another variable to control in the UI experience.

Another prior art technique uses off-line calibration and then introduces the calibration during actual use. This method is not robust because the conditions used during the calibration may have changed and the result thus may not be optimal.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration of a handheld device in accordance with one or more embodiments;

FIG. 2 is a system block diagram in accordance with one or more embodiments;

FIG. 3 is a diagram depicting cursor movement caused by a user progressing toward targets on a display in accordance with one or more embodiments;

FIG. 4 is a graph showing progressive positions on a display caused by user input on a joystick or the like device in accordance with one or more embodiments;

FIG. 5 is a chart illustrating the progressive positions on a display in a numeric format suitable for smoothing or stabilization caused by user input on a device as shown in FIG. 4 in accordance with one or more embodiments;

FIG. 6 is a graph illustrating the progressive positions on a display caused by user input on a device as shown in FIG. 4 and a linear regression of the same in accordance with one or more embodiments;

FIG. 7 is a graph illustrating the progressive positions on a display caused by user input on a device as shown in FIG. 4 and a polynomial curve fitting of the same in accordance with one or more embodiments;

FIG. 8 is a flow chart illustrating a method in accordance with one or more embodiments;

FIG. 9 is a schematic diagram in accordance with one or more embodiments; and

FIG. 10 is another flow chart illustrating a method in accordance with one or more embodiments.

### DETAILED DESCRIPTION

In overview, the instant disclosure concerns user interfaces for electronic devices that are expected to provide an improved user experience and more specifically techniques and apparatus for optimizing the user's interaction with the user interface, e.g., cursor movement, etc. to converge on intended targets, based on user input alone. The techniques and apparatus are particularly arranged and constructed for mobile or handheld devices or other devices where a user may be subject to, e.g., environmental factors, user activities, or some nervous disorder any of which may result in erratic user input. More particularly various inventive concepts and principles embodied in methods and apparatus, for cell phones, Personal Digital Assistants (PDAs), handheld games and other handheld or otherwise devices that require user input will be discussed and disclosed.

In systems, equipment and devices that employ user interfaces, the apparatus and methods described herein and associated improved user experience can be particularly advantageously utilized, provided they are practiced in accordance with the inventive concepts and principles as taught herein.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in integrated circuits (ICs) including possibly application specific ICs or ICs with integrated processing controlled by embedded software or firmware. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the various embodiments.

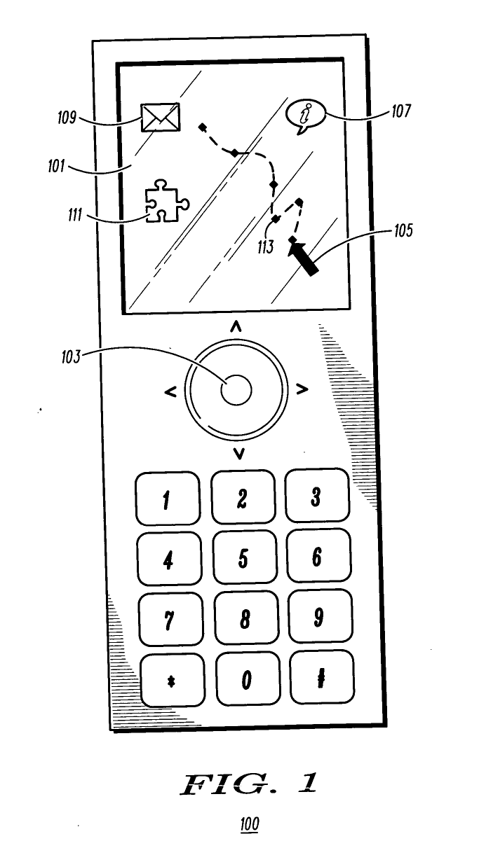

Referring to FIG. 1, an illustration of a handheld or portable device in accordance with one or more embodiments will be introduced. In FIG. 1 a device 100 has a display screen 101. This display screen 101 is in one or more embodiments a Liquid Crystal Display (LCD). This display 101 can be either color or monochrome. Other types of displays such as plasma, or similar function displays are also contemplated. A joystick 103 or the like device is present for inputting a user's command that is translated into, e.g., movement of a cursor 105 on the display screen 101. Note that one may substitute other equivalent input transducers for the joystick 103 such as a trackball, touchpad or other devices without departing from the essential teachings. For example when the joystick 103 is moved toward the display screen 101 the cursor 105 will be guided to move in the same direction. For example, a user may choose to move the cursor 105 toward a target 107, 109, and/or 111 using the joystick 103 for the purpose of selecting one of the targets 107, 109, and/or 111. In the illustration target 107 is an icon for displaying information, target 109 is an icon for opening up an email program, and target 111 is an icon for invoking a puzzle game. The target example is used in this discussion as a simple example and it is understood that the user may simply wish to move the cursor in some manner or direction for any number of reasons other than selecting a target and any of these movements can be subjected to irregularities. Those skilled in the art will readily recognize many variants of the targets and their corresponding function without departing from the essential teachings herein.

In operation a user will move the joystick 103 which in turn moves or results in movement of the cursor 105 towards one of the targets 107, 109, or 111. Since the portable device 100 is held in the user's hand the efficient coordination of the joystick 103 guiding the cursor 105 to the intended target can sometimes be difficult. In an example shown here reference number 113 illustrates five traversals of the cursor 105 caused by inconsistent or erratic movement of the cursor 103 toward target 109. As is generally appreciated, e.g., see Fitt's Law as related to target acquisition efficiency, movements are more efficient when the total travel to the target is minimized. Below various figures and embodiments will be introduced that describe and discuss various techniques to improve the user experience by mitigating the inconsistent movement just detailed. Note also that those skilled in the art will readily recognize many variant devices and corresponding functions without departing from the essential teachings of the present disclosure. For example the device 100 can be a cellular radiotelephone but could also be a PDA, a handheld game, or any other such device that allows a user to move a cursor on a display under the command of an input transducer such as a joystick.

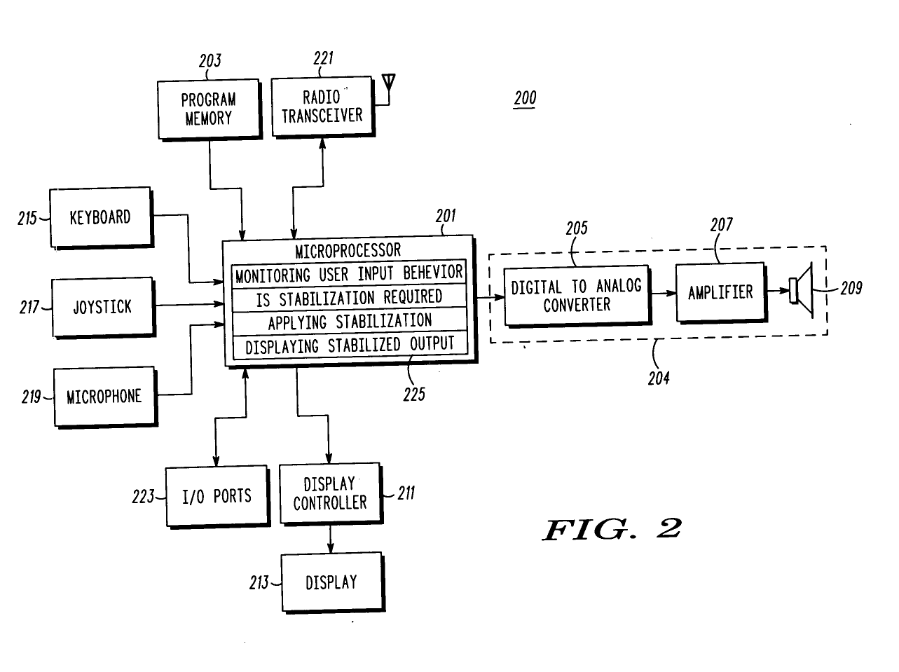

Referring to FIG. 2, a system block diagram 200 in accordance with one or more embodiments will be introduced, described, and discussed. FIG. 2 shows one of many useful instantiations of a portable or handheld device in accordance with one or more embodiments described herein. Note that this apparatus could be a cell phone, an MP3 player, a Personal Digital Assistant, a hand held game or any other such handheld device that allows user input to be entered via a transducer such as a joy stick, trackball, touchpad or other equivalent device and a display where input via the transducer is correspondingly displayed.

Central to the device is a controller that includes or is based on a microprocessor 201. The microprocessor 201 executes instructions that are stored in a program memory 203. Note that the microprocessor and memory are generally known and widely available and the memory may take many forms including various volatile and non-volatile forms of memory and that the memory may be embedded with the microprocessor. In block 204 a digital to analog converter 205, amplifier 207 and speaker 209 are coupled to the microprocessor 201 in sequence and are used to annunciate sound as required by some exemplary devices. For example, in a cellular radiotelephone, elements 205, 207 and 209 may deliver a voice conversation or other useful audio information. Those of ordinary skill in the art will readily recognize many alternative techniques of producing sound or providing other functionality that are largely in line with the intent illustrated without deviating substantially from the devices shown here.

A display controller 211 and a display 213 are coupled to the microprocessor 201 in sequence and are used to display relevant information to a user. User input devices include a keyboard 215, a joystick 217 and a microphone 219. Of course the keyboard 215 could be a keypad and, as described earlier, the joystick 217 may be a trackball, touchpad or other such equivalent devices without departing from the essential teachings detailed herein. As described earlier, portions of some of these elements may be reduced to a single IC for convenience.

Also, typical of cell phones, MP3 players, Personal Digital Assistants, and hand held games are I/O ports shown at reference number 223. These may include serial, parallel, USB, Bluetooth, Wi-Fi, ZigBee, Ethernet, and a sundry of other I/O device interfaces convenient to the use of the device 200. A radio transceiver 221 is also connected to the microprocessor 201 which is useful for cell phone devices as well as any devices benefiting from various wireless interfaces.

The microprocessor 201 in various embodiments is programmed to execute or otherwise facilitate one or more of the various methods described below. One example 225 shows the microprocessor 201 monitoring user input behavior or corresponding input data—for example the user's movement of the joystick 217, determining whether or when stabilization is appropriate or required—using one of many methods; some detailed below, applying one or more forms of stabilization to the data as needed, and displaying or otherwise outputting stabilized output data using, e.g., the display controller 211 and the display 213. Again, the diagram illustrated here is meant to be a general example of an apparatus for implementing the described methods and those skilled in the art will find many equivalent embodiments without deviating from the essential teaching.

Referring to FIG. 3, a diagram depicting cursor movement caused by a user progressing toward targets on a display in accordance with one or more embodiments is detailed. FIG. 3 depicts cursor movement by a user on a display 300. As described in reference to FIG. 1 a user can use a joystick, or other suitable actuator/sensor, to move a cursor 301 on the display 300. The user typically may cause the cursor 301 to move along predominant paths or trajectories 303, 305 or 307 to reach targets 304, 306 or 308, respectively. An actual and exemplary path of travel caused by or resulting from input data corresponding to user input is shown using reference numbers 309, 311, 313, 315, 317, 319, 321, 323, and 325. By observation of this actual path of travel it's apparent or at least likely that the user intends that the cursor 301 move toward target 306. However, because of motion induced variability caused by a user or the environment while the user interacts with the device, the cursor moves erratically thereby potentially frustrating the user.

Reference number 327 illustrates a modified trajectory or path of the cursor that converges towards target 306 in a more efficient or direct manner. This efficiency is afforded by smoothing the trajectory of the cursor movement. This smoothing can be effected by many means such as linear regression, various forms of non-linear regression such as polynomial, Boltzmann sigmoidal, and least-squares, and interpolation in arrears. Predictive methods such as particle filters, Kalman-Bucy state estimators, Monte Carlo filters, or non-linear observers including sliding-mode observers, observers based on Popov's hyperstability, or neural network based observers may also be used. The predictors or observers may be slightly more effective because they do not wait for new data to do a post analysis. Precise prediction techniques are commonly found in the art and therefore not detailed here. The reader is instead directed to consider using commercially available programs such as MatLab® (registered trademark of The Mathworks, Inc., of Natick, Mass.), O-Matrix (distributed by Harmonic Software, Inc., of Breckenridge, Colo.), and the like. In the embodiment described with reference to FIG. 2, these or other predictive-type programs are loaded into the program memory 203 and executed on the microprocessor 201. Various convergence techniques will be detailed next.

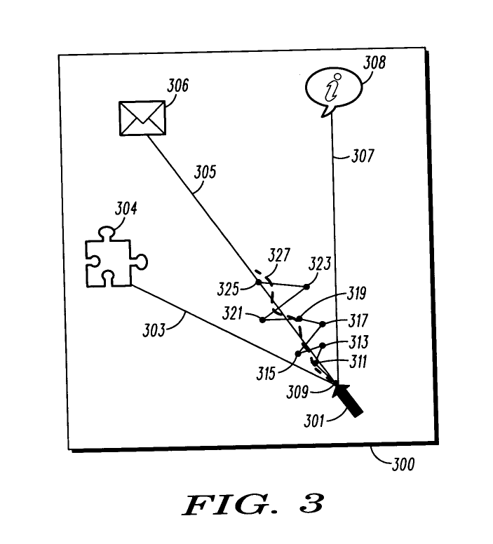

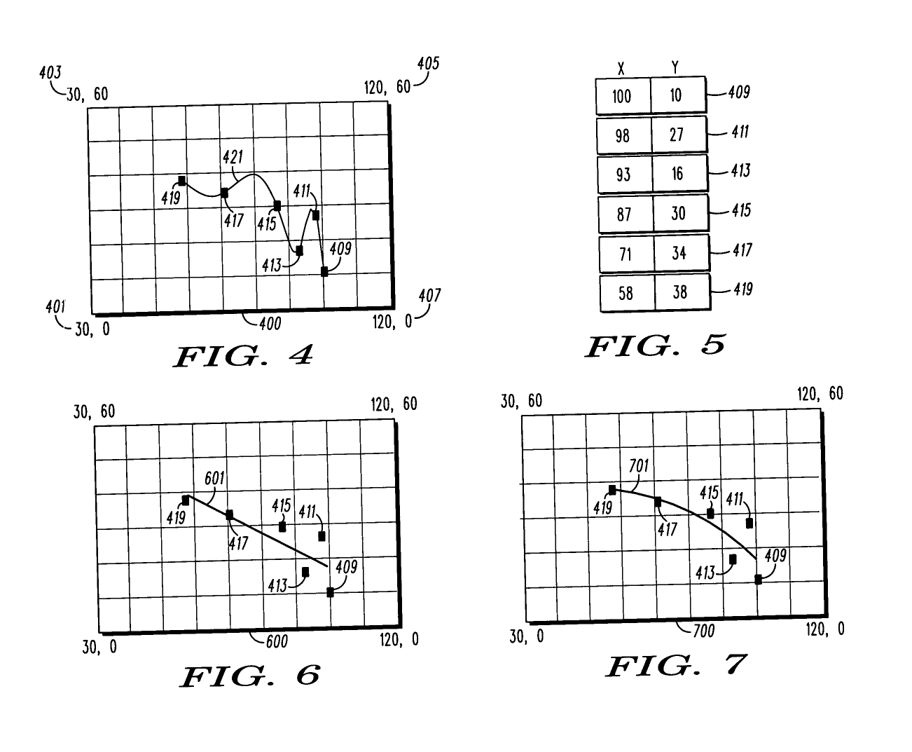

Referring to FIG. 4, an exemplary graph showing progressive positions on a display caused by user input on a joystick like device in accordance with one or more embodiments is detailed. Here a display 400, which represents a portion of the earlier described display screen 101 from FIG. 1 is bounded by an origin position 401 located at pixel position 30, 0 another position 403 located at pixel position 30, 60, another position 405 located at pixel position 120, 60, and a final position 407 located at pixel position 120, 0. These pixel positions are used to numerate the joystick positions for later analysis and smoothing for mitigating effects of motion induced variability caused by a user or the environment while the user interacts with a device.

Joystick movement is shown at representative positions commencing at 409 and traversing to 419 via 411, 413, 415, and 417. Again these positions 409-419 represent movement by a joystick like input device without any compensation for motion induced variability caused by a user or the environment while the user interacts with a device. Curve 421 shows the continuous movement between positions 409-419. Note that position 409 is located on the diagram at 100, 10. The other positions will be numerated in the next figure. In an actual embodiment tens or hundreds of additional positions along the curve 421 could be available and recorded although processing resources (memory and processor cycles) likely favor fewer rather than more positions. Creating an effective and user friendly interface may require some tradeoffs between number of positions and processing resources that are used.

Referring to FIG. 5, a chart illustrating the progressive positions on a display in a numeric format suitable for smoothing or stabilization caused by user input on a joystick device shown in FIG. 4 in accordance with one or more embodiments is detailed.

As mentioned above 100, 10 represent position 409. Also 98, 27 represent position 411. The pair 93, 16 represents position 413. The pair 87, 30 represents position 415. The pair 71, 34 represents position 417. And, 58, 38 represent position 419. These position coordinate pairs will be used in a numerical analysis pursuant to mitigating effects of motion induce variability caused by a user or the environment while the user interacts with a device.

Referring to FIG. 6, a graph illustrating the progressive positions on a display caused by user input on a joystick device shown in FIG. 4 and the results or effect of a linear regression applied to the progressive positions in accordance with one or more embodiments is detailed.

Line 601 represents a computational result of a linear regression of the data represented on graph 600. The data is the same data introduced earlier namely the input data corresponding to user input behavior shown here using reference numbers 409, 411, 413, 415, 417, and 419 respectively. Here linear regression has been used to model a relationship between two variables X and Y by fitting a linear equation to observed data. One variable, for example X from FIG. 5, is considered to be an explanatory variable, and the other, for example Y from FIG. 5, is considered to be a dependent variable. A linear regression line has an equation of the form Y=mX+b, where X is the explanatory variable and Y is the dependent variable. The slope (m) and the Y-intercept (b) must then be computed.

Here's an example of how linear regression is computed. Given a set of data (X, Y) with (n) data points, the slope (m), y-intercept and correlation coefficient (r) can be computed using the following three equations:

$$m = \frac{n \sum ( x y ) - \sum x \sum y}{n \sum ( {x}^{2} ) - {( \sum x )}^{2}}$$

$$b = \frac{\sum y - m \sum x}{n}$$

$$y = \frac{n \sum ( x y ) - \sum x \sum y}{\sqrt{[ n \sum ( {x}^{2} ) - {( \sum x )}^{2} ] [ n \sum ( {y}^{2} ) - {( \sum y )}^{2} ]}}$$

The computed result is line 601 in FIG. 6.

It will be appreciated that by filtering or stabilizing the data set created by joystick motion prior to display an improved user experience can be realized when motion induced variability is caused by a user or the environment while the user interacts with a device.

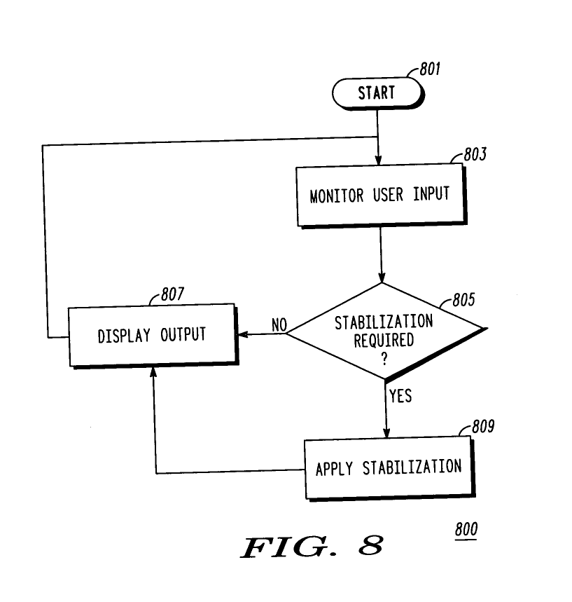

Referring to FIG. 7 an exemplary graph illustrating the progressive positions on a display caused by user input on a joystick device shown in FIG. 4 and a polynomial curve fitting of these positions in accordance with one or more embodiments is detailed.

Line 701 represents a computational result of a nonlinear regression of the data represented on graph 700. The data is the same data introduced earlier namely the input data corresponding to user input behavior shown here using reference numbers 409, 411, 413, 415, 417, and 419 respectively. Here a second order polynomial e.g. Y=A+BX+CX² is used. The precise technique is commonly found in the art and therefore not detailed here. The reader is instead directed to consider using commercially available programs such as CurveExpert, GraphPad Prism, and the like. In the embodiment described with reference to FIG. 2, these or other regression-type programs are loaded into the program memory 203 and executed on the microprocessor 201. Thus as input data is received from the joystick or like device, rather than displaying cursor motion equal to the input data, the input data will be stabilized, e.g., via a regression analysis and the cursor will be moved in accordance with the stabilized data, e.g., according to curve 601 or 701 if appropriate.

It will be appreciated that by filtering or stabilizing the data set created by joystick motion prior to display an improved user experience can be realized when motion induced variability is caused by a user or the environment while the user interacts with a device.

Referring to FIG. 8 a flow chart illustrating a method in accordance with one or more embodiments is detailed. Referring to the flow chart in FIG. 8, one or more embodiments of methods of stabilizing output corresponding to user input behavior will be discussed and described. A method 800 starts at 801. Next in 803 user input behavior, i.e., input data corresponding to user input behavior, is monitored and a method of stabilizing output data corresponding to user input data is detailed. In this case the monitored user input behavior would be any movement of the above mentioned joystick or like devices. This movement could be caused or effected by the user or the environment while the user interacts with a device where the resultant input data is essentially a combination of desired input data and undesired or undesirable input data.

Next, in 805 an algorithm, or equivalent method, is used to determine, after and responsive to the monitoring 803, whether or not stabilization, or smoothing, of the input data or user's input is necessary, required, or appropriate, i.e. whether stabilization of output data corresponding to the input data is appropriate or required.

For example various statistical tests can be applied to the data set generated by the user when the joystick is moved. One method of determining a need for stabilization is to look at the statistical variance of the user input data. If the variance is too high e.g. greater than a predetermined allowed variance, then stabilization may be indicated or required. Variance can be computed for a population of data using the following equation:
s²=Σ(X−M)²/(N−1)
where M is the mean and N is the number of scores or data points. Note that the square root of the variance is commonly referred to as the standard deviation which is most commonly used to measure spread from the mean of a data set.

Returning to the example, as new data is available caused by movement of the joystick, or equivalent device, its variance is computed and compared to a threshold. If the variance exceeds the threshold then stabilization is required. Optimally, this threshold will be determined by experimenting with the physics of the joystick in the hands of a user. This is preferable because joysticks have various force models. After experimentation with a subject device, such as the device 100 introduced in FIG. 1 and the joystick 103 if a threshold of 15% variance is determined then a greater than 15% variance test will be applied to the instant data in view of the historical data. If the statistical variance exceeds this 15% threshold, then stabilization will be applied to the instant data before it's displayed. If the statistical variance does not exceed this 15% threshold, then stabilization will not be applied to the instant data before it's displayed.

Various other stabilization methods include linear and non-linear curve fitting as described in other embodiments detailed herein. Note that a mean square error or difference between the curve resulting from regression and the actual data may be used as a test to determine whether stabilization is appropriate or required.

If stabilization is not required, the data is displayed, i.e., the cursor is displayed in accordance with the input data, in 807 and the method repeats by returning to 803. If stabilization is required, then stabilization is applied and the stabilized output data is displayed in 809. Referring back to FIG. 1 reference number 137 illustrates the result of the stabilization of the displayed cursor. Other examples of this are illustrated in FIG. 6 and FIG. 7. It will be appreciated that this method uses many of the inventive concepts and principles discussed in detail above and thus this description will be somewhat in the nature of a summary with various details generally available in the earlier descriptions. Those skilled in the art will recognize that this method can be implemented in one or more of the structures or apparatus described earlier or other similarly configured and arranged structures. The described method can be repeated continuously to optimize the user experience.

A simple method (in addition to the regression techniques noted above) of applying stabilization is to substitute a running average for the instant data if it exceeds the threshold test 805. So if in 805 the statistical variance of the instant data exceeds the 15% threshold, then stabilization will be applied to the instant data before it's displayed. If the statistical variance of the instant data does not exceed this 15% threshold, then stabilization will not be applied to the instant data before it's displayed, but rather it will be displayed without modification. Those skilled in the art will readily recognize many other tests of stabilization determination including median filtering, shape, trimean, etc.

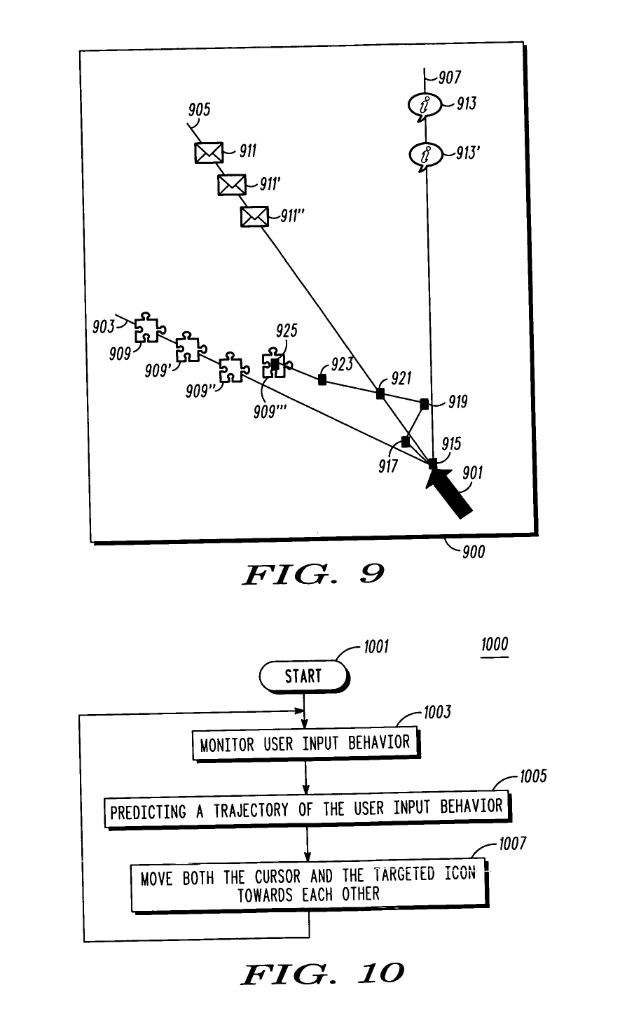

Referring to FIG. 9 an exemplary diagram illustrating movements on a display in accordance with one or more embodiments is detailed. FIG. 9 is a diagram of an alternative embodiment of the invention depicting cursor movement, etc. on a display 900 resulting from movement of a joystick caused by a user. As described earlier the user can use a joystick, or other suitable actuator/sensor to move a cursor 901 on the display 900. The user can cause the cursor 901 to move along predominant paths or trajectories 903, 905 or 907 towards targets, or target display elements, 909, 911, or 913 respectively. In this example the targets 909, 911, and 913 will actually converge on the cursor movement dependent on a user driving a joystick causing the cursor to favor a specific target 909, 911, or 913.

To start the cursor 901 moves to a first position 915. Since this movement is predominantly associated with path 903 target 909 traverses to a new position depicted by 909′ and targets 911 and 913 remain in their original position. Next the cursor, or display element, moves to a position noted by reference number 917. Said another way the cursor moves towards the targets on path 905. Since this movement aligns predominantly with path 905 target 911 traverses to a position denoted by 911′, and targets associated with paths 903 and 907 remain static.

Then the cursor progresses to a position denoted by reference number 919 that favors path 907 so target 913 moves to 913′ while targets on paths 903 and 905 remain stationary. When the cursor transitions to 921 both targets 911′ and 909′ progress to 911″ and 909″ respectively and targets on path 907 remain stationary. Next the cursor moves to position 923 and target 909′ responds by moving to position 909″ and targets on paths 905 and 907 remain stationary.

Finally the cursor moves to position 925 and target 909″ responds by moving to position 909′″ and the target and cursor converge to position 925 and targets on paths 905 and 907 remain stationary. It's clearly evident here that the targets on path 903 converge to the traversal of the cursor thus improving or optimizing the user experience. In fact both the cursor symbol and the target display element, in this case an icon, converge towards each other. In other words the cursor to icon connection will resolve faster, improving the user experience. Next a method of affecting the described behavior will be described.

Referring to FIG. 10 another flow chart illustrating a method 1000 in accordance with one or more embodiments is detailed. Referring to the flow chart in FIG. 10 a method starts at 1001. Next in 1003 user input behavior, i.e., input data corresponding to such behavior, is monitored. In this case the monitored user input behavior would be any movement of the above mentioned joystick or equivalent device used to command a display cursor such as element 901 introduced in FIG. 9 above.

Next, in 1005 a trajectory of the user's input behavior is predicted. Essentially new, or future input data is estimated or predicted based on past user input data. Predictive methods such as particle filters, Kalman-Bucy state estimators, Monte Carlo filters, or non-linear observers including sliding-mode observers, observers based on Popov's hyperstability, or neural network based observers may also be used. The predictors or observers may be slightly more effective because they do not wait for a large set of data to do a post analysis but rather estimate or predict new datum based on the available old data. Details of the precise prediction techniques are commonly found in the art and therefore not detailed here. As noted earlier the reader is instead directed to consider using commercially available programs such as Matlab, O-Matrix, and the like. In the embodiment described with reference to FIG. 2, these or other predictive-type programs are loaded into the program memory 203 and executed on the microprocessor 201.

Referring to both FIG. 9 and FIG. 10, in 1007 the cursor 901 and one (909, 909′, 909″, 909′″) of several display icons (909, 911, 913) move towards each other and the method repeats continuously returning to 1003. One advantage of the just-described method is that the user will be able to more quickly select display icons. In view of mitigating effects of motion induced variability caused by a user or the environment this is very advantageous. Also because a predictive method is used the cursor to icon will resolve faster, again improving the user experience.

It will be appreciated that this method uses many of the inventive concepts and principles discussed in detail above and thus this description is somewhat in the nature of a summary with various details generally available in the earlier descriptions. This method can be implemented in one or more of the structures or apparatus described earlier or other similarly configured and arranged structures.

The processes, apparatus, and systems, discussed above, and the inventive principles thereof are intended to and can alleviate user interface issues caused by prior art techniques. For example when motion induced variability is caused by a user, or the environment, while the user interacts with a device by applying force to a joystick or the like, the improved approach measures and mitigates the motion induced variability. This is accomplished first by monitoring the user input behavior by observing input date, e.g., the joystick data. Next a test of stability of the instant data is made, e.g., by comparing it to the historical data generated by the user behavior. If the instant data is too erratic or variant from the historical data, then stabilization will be applied using various means. These means include statistical filtering, regression, curve fitting, and various forms of prediction including particle filters, Kalman-Bucy state estimators, Monte Carlo filters, or non-linear observers including sliding-mode observers, observers based on Popov's hyperstability, or neural network based observers. After stabilization the result is output to a display, in one case a new cursor position as detailed in FIG. 8.

In another embodiment shown in FIG. 10 a method was detailed that allowed the user to be able to more quickly select display icons. In view of mitigating effects of motion induced variability caused by a user or the environment this is very advantageous. In this embodiment because a predictive method was used, the cursor to icon mating or converging will resolve faster, again improving the user experience.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of stabilizing output corresponding to user input behavior, the method comprising:
monitoring input data corresponding to user input behavior;
determining, responsive to the monitoring, when stabilization of input data is required;
stabilizing, responsive to the determining when stabilization of input data is required, data corresponding to the input data to provide stabilized data; and
outputting the stabilized data.

2. A method in accordance with claim 1 wherein the monitoring input data corresponding to user input behavior comprises monitoring input data corresponding to movement of an input transducer.

3. A method in accordance with claim 2 wherein the monitoring input data corresponding to user input behavior comprises monitoring input data corresponding to movement of at least one of a joystick, a trackball, and a touchpad.

4. A method in accordance with claim 3 wherein the stabilizing comprises smoothing the input data corresponding to user input behavior to provide the stabilized data.

5. A method in accordance with claim 4 wherein the outputting further comprises displaying the stabilized data.

6. A method in accordance with claim 5 wherein the smoothing comprises linear regression of the input data corresponding to user input behavior to provide the stabilized data.

7. A method in accordance with claim 5 wherein the smoothing comprises polynomial regression of the input data corresponding to user input behavior to provide the stabilized data.

8. A method in accordance with claim 5 wherein the smoothing comprises stabilizing by predicting new input data corresponding to past user input data corresponding to user input behavior to provide the stabilized data.

9. A method in accordance with claim 8 wherein the smoothing comprises stabilizing by predicting a trajectory of new input data corresponding to past user input data corresponding to user input behavior to provide the stabilized data.

10. A method of stabilizing movement of display elements corresponding to user input behavior, the method comprising:
monitoring input data corresponding to user input behavior; and
moving both a display element and one of a plurality of target display elements dependant on the monitoring of input data corresponding to user input behavior.

11. A method in accordance with claim 10 wherein the moving a display element comprises moving a cursor symbol.

12. A method in accordance with claim 11 wherein the moving further comprises moving at least one of both the cursor symbol and the one of the plurality of target display elements to converge towards each other.

13. A method in accordance with claim 11 wherein the moving further comprises moving both the cursor symbol and the one of a plurality of target display elements to converge towards each other.

14. A method in accordance with claim 10 further comprising:
predicting a trajectory of the input data corresponding to user input behavior, wherein the moving a display element towards one of a plurality of target display elements corresponds to the trajectory.

15. A method in accordance with claim 14 wherein another of the plurality of target display elements remains stationary while the cursor symbol and the one of a plurality of target display elements are both moving and converging towards each other.

16. A method in accordance with claim 10 wherein another of the plurality of target display elements remains stationary while the display element and the one of a plurality of target display elements are both moving.

17. A system for mitigating effects of motion induced variability caused by a user or the environment while the user interacts with a device, the system comprising:
an input device for sensing user interaction;
a display for displaying a cursor icon and at least one target icon;
a controller coupled to the input device and the display for stabilizing the sensed user interaction and for moving the cursor icon dependant on the stabilizing the sensed user interaction.

18. A system in accordance with claim 17 wherein the input device comprises a at least one of a joystick, a trackball, and a touchpad.

19. A system in accordance with claim 18 wherein the display displays a plurality of target icons.

20. A system in accordance with claim 19 wherein the controller causes both the cursor icon and one of the plurality of icons to converge towards each other.
